(19) United States
(12) Patent Application Publication
(10) Pub. No.: US 2020/0254983 A1
(43) Pub. Date: Aug. 13, 2020

(54) BRAKE FORCE CONTROL SYSTEM FOR VEHICLE

(71) Applicant: Toyota Jidosha Kabushiki Kaisha, Toyota-shi (JP)

(72) Inventors: Yusuke SUZUKI, Hadano-shi (JP); Masaki OKAMURA, Toyota-shi (JP); Junichi MURASE, Susono-shi (JP); Fumito ITOH, Susono-shi (JP)

(73) Assignee: Toyota Jidosha Kabushiki Kaisha, Toyota-shi (JP)

(21) Appl. No.: 16/777,323

(22) Filed: Jan. 30, 2020

(30) Foreign Application Priority Data
Feb. 7, 2019 (JP) 2019-020278

(51) Int. Cl. B60T 7/12; B60T 7/06; B60K 31/00

(52) U.S. Cl. CPC B60T 7/12; B60T 2210/24; B60K 31/0066; B60T 7/06

(57) ABSTRACT

A brake force control system configured to allow a driver to control brake force finely only by operating an accelerator pedal, and to decelerate a vehicle to a target speed only by operating the accelerator pedal. The control system calculates a target deceleration to travel through a target site at a target speed in accordance with a decelerating factor. If a reference deceleration generated by returning the accelerator pedal to an initial position is equal to or less than the target deceleration, the control system increases the reference deceleration.

### CROSS REFERENCE TO RELATED APPLICATIONS

The present disclosure claims the benefit of Japanese Patent Application No. 2019-020278 filed on Feb. 7, 2019 with the Japanese Patent Office, the disclosure of which are incorporated herein by reference in its entirety.

### BACKGROUND

### Field of the Disclosure

Embodiments of the present disclosure relate to the art of a brake force control system for a vehicle that controls a brake force based on an operating amount of an acceleration pedal.

### Discussion of the Related Art

JP-A-2016-141232 describes a vehicle control device that controls a braking force configured to generate a driving force when an accelerator pedal is depressed from a predetermined reference point of a pedal stroke, and to generate a braking force when a when the accelerator pedal is released from the reference point. According to the teachings of JP-A-2016-141232, the braking force is increased when a rate of change in a pedal operation amount when the pedal is released is equal to or greater than a first threshold value.

JP-A-2007-230440 describes a vehicle travel controlling apparatus configured to calculate a target vehicular speed for cornering a curve in a path of the vehicle based on a radius of the curve, and to correct a target deceleration based on the target vehicular speed. According to the teachings of JP-A-2007-230440, if the accelerator pedal is operated before the vehicle enters into a curve or during travelling through the curve, the target deceleration is reduced in accordance with the operation of the accelerator pedal. By contrast, the target deceleration is increased if the accelerator-pedal-release speed is equal to or greater than a predetermined value.

JP-A-2001-233085 describes a vehicle deceleration control apparatus configured to decelerate a vehicle by an engine braking effect achieved when an accelerator pedal is returned to reduce injection of air/fuel mixture, and by an assist deceleration applied from a braking system. According to the teachings of JP-A-2001-233085, the assist deceleration is increased with a reduction in a distance from a vehicle running ahead.

JP-A-2004-142686 describes a running controller for a vehicle. According to the teachings of JP-A-2004-142686, when target speed to travel through a curve is lower than own vehicle speed, the running controller decelerates the vehicle preliminarily by smaller deceleration, and then further decelerates the vehicle by greater deceleration.

In the conventional vehicle in which a one-pedal mode is available as described e.g., in JP-A-2016-141232, a maximum brake force is generated when the accelerator pedal is not depressed to be situated at an initial position, and a maximum drive force is generated when the accelerator pedal is fully depressed. However, if a stroke range of the accelerator pedal is too wide, the brake force or drive force would be changed more than expected even if a driver operates the accelerator pedal only slightly. That is, it is difficult to adjust the brake force or drive force finely in line with the driver's intension. Therefore, in order to control the brake force or drive force by the common pedal, the maximum brake force to be generated when the pedal is positioned at the initial position has to be reduced smaller than a structural maximum brake force available in the vehicle.

However, if the maximum brake force to be generated when the pedal is positioned at the initial position is thus reduced, the vehicle may not be decelerated to a target speed by merely returning the pedal to the initial position when e.g., entering a curve despite the intension of the driver. In addition, if the vehicle cannot be decelerated to the target speed, the vehicle may come too close to a vehicle ahead.

For the reasons above stated, in the vehicle in which the one-pedal mode is available as described in JP-A-2016-141232 or JP-A-2007-230440, the brake force may not be increased sufficiently to decelerate the vehicle to the target speed if e.g., the driver returns the accelerator pedal slowly way before entering a curve. In this situation, the driver has to depress a brake pedal to decelerate the vehicle to the target speed. If the brake force is increased automatically with a reduction in a distance from a vehicle ahead as taught by JP-A-2001-233085, the brake force may be increased greater than that intended by the driver. Thus, the conventional vehicles in which the one-pedal mode is available have to be improved to allow the driver to control the brake force finely only by operating the accelerator pedal.

### SUMMARY

Aspects of the present disclosure have been conceived noting the foregoing technical problems, and it is therefore an object of the present disclosure to provide a brake force control system configured to allow a driver to control brake force finely only by operating an accelerator pedal, and to decelerate a vehicle to a target speed only by operating the accelerator pedal.

The brake force control system according to the embodiment of the present disclosure is provided with a controller that controls a brake force based on a deceleration determined with respect to a position of an accelerator pedal within a predetermined range. Specifically, the controller is configured to: calculate a target deceleration to travel through a target site existing predetermined distance ahead of the vehicle at a target speed, in accordance with a decelerating factor determined based on information ahead of the vehicle; and correct a reference deceleration generated by returning the accelerator pedal to an initial position, if the reference deceleration is equal to or less than the target deceleration.

In a non-limiting embodiment, the corrected reference deceleration may be set to the target deceleration.

In a non-limiting embodiment, the controller may be further configured to: calculate a plurality of the target decelerations depending on number of the decelerating factors; and compare the greatest target deceleration to the reference deceleration to correct the reference deceleration.

In a non-limiting embodiment, the controller may be further configured to: indicate danger or activate an automatic brake system thereby generating the brake force irrespective of the position of the accelerator pedal; or indicate danger and activate the automatic brake system thereby generating the brake force irrespective of the position of the accelerator pedal, if the target deceleration is equal to or greater than the predetermined deceleration.

In a non-limiting embodiment, the target deceleration may be calculated based on a current speed of the vehicle, the target speed, and the predetermined distance to the target site.

In a non-limiting embodiment, the decelerating factor may include a situation when travelling through a curve in a stable manner, and the controller may be further configured to reduce the target speed with a reduction in a radius of the curve.

In a non-limiting embodiment, the decelerating factor may include a situation when decelerating the vehicle to keep a distance from a vehicle running ahead, and the target speed may be calculated taking account of a speed of the vehicle running ahead.

In a non-limiting embodiment, the controller may comprise a map increasing the deceleration with a reduction in depression of the accelerator pedal toward the initial position within the predetermined range. In addition, the controller may be further configured to correct the map in such a manner as to increase a change in the deceleration with respect to the position of the accelerator pedal if the reference deceleration is equal to or less than the target deceleration.

Thus, according to the exemplary embodiment of the present disclosure, the target deceleration is calculated in accordance with the decelerating factor detected based on information ahead of the vehicle. In the case that the reference deceleration to be generated by returning the accelerator pedal to the initial position is less than the target deceleration, the controller corrects the reference deceleration to increase a greater brake force. According to the exemplary embodiment of the present disclosure, therefore, the deceleration of the vehicle may be controlled by manipulating only the accelerator pedal, without operating a brake pedal. In addition, since the driver is allowed to adjust the deceleration manually by manipulating the accelerator pedal, the deceleration of the vehicle can be controlled in line with an intension of the driver.

### BRIEF DESCRIPTION OF THE DRAWINGS

Features, aspects, and advantages of exemplary embodiments of the present disclosure will become better understood with reference to the following description and accompanying drawings, which should not limit the disclosure in any way.

FIG. 1 is a schematic illustration showing one example of a structure of a vehicle to which the control system according to the embodiment of the present disclosure is applied;

FIG. 2 is a map for determining deceleration of the vehicle with respect to a position of an accelerator pedal;

FIG. 3 is a flowchart showing one example of a routine executed by the brake force control system according to the embodiment of the present disclosure; and

FIG. 4 is a map corrected to increase a change in deceleration with respect to a position of the accelerator pedal.

### DETAILED DESCRIPTION

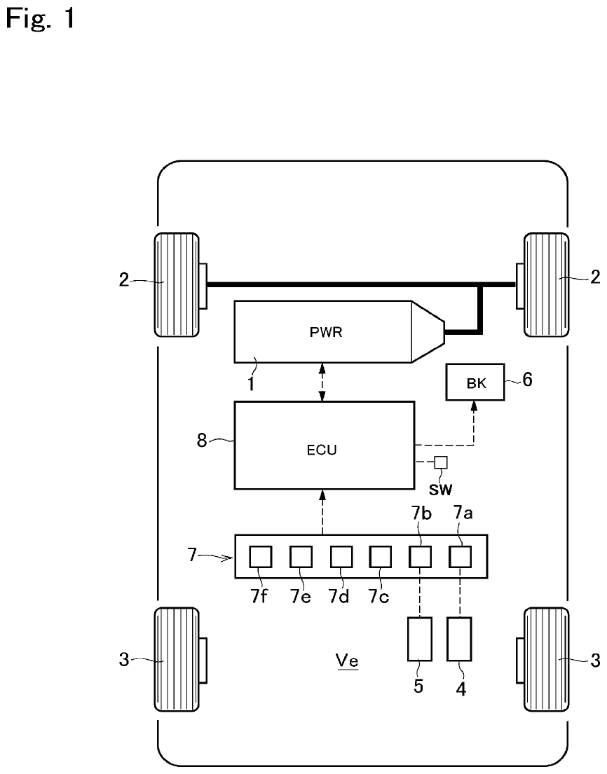

Embodiments of the present invention will now be explained with reference to the accompanying drawings. Referring now to FIG. 1, there is shown an example of a drive system and a control system of a vehicle Ve to which the brake control system according to the exemplary embodiment of the present disclosure is applied. The vehicle Ve comprises a prime mover (referred to as “PWR” in FIG. 1) 1, a pair of front wheels 2, a pair of rear wheels 3, an accelerator pedal 4, a brake pedal 5, a brake device (referred to as “BK” in FIG. 1) 6, a detector 7, and an electronic control unit (to be abbreviated as the “ECU” hereinafter) 8 as a controller.

The prime mover 1 generates a drive torque to establish a driving force to propel the vehicle Ve. For example, an internal combustion engine such as a gasoline engine and a diesel engine may be adopted as the prime mover 1. An output power of the engine may be adjusted electrically, and the engine may be started and stopped electrically according to need. Given that the gasoline engine is adopted as the prime mover 1, an opening degree of a throttle valve, an amount of fuel supply or fuel injection, a commencement and a termination of ignition, an ignition timing etc. may be controlled electrically. Otherwise, given that the diesel engine is adopted as the prime mover 1, an amount of fuel injection, an injection timing, an opening degree of a throttle valve of an EGR (Exhaust Gas Recirculation) system etc. may be controlled electrically.

Further, a permanent magnet type synchronous motor, and an induction motor may be adopted as the prime mover 1. Those kinds of motors may serve not only as a motor to generate torque when driven by electricity suppled thereto, but also as a generator to generate electricity when rotated by a torque applied thereto. That is, a motor-generator may also be adopted as the prime mover 1. In this case, the prime mover 1 is switched between a motor and a generator by electrically controlling the prime mover 1, and an output speed and an output torque of the prime mover 1 may be controlled electrically.

In the vehicle Ve shown in FIG. 1, the front wheels 2 serve as drive wheels, and a drive torque generated by the prime mover 1 is delivered to the front wheels 2 to propel the vehicle Ve. However, the brake force control system according to the embodiment of the present disclosure may also be applied to a rear-drive layout vehicle in which rear wheels serve as drive wheels, and a four-wheel drive vehicle in which all of wheels are driven by the torque of the prime mover. In a case of using the engine as the prime mover 1, a transmission (not shown) may be arranged downstream of the prime mover 1 to deliver the output torque of the prime mover 1 to the drive wheels via the transmission.

The prime mover 1 generates a torque by depressing the accelerator pedal 4 thereby establishing the drive force to propel (or accelerate) the vehicle Ve. The torque of the prime mover 1 is increased in accordance with an increase in depression of the accelerator pedal 4. In other words, the drive force to propel the vehicle Ve is increased in accordance with a position of the accelerator pedal 4. By contrast, the torque of the prime mover 1 is reduced by returning the accelerator pedal 4. In other words, the torque of the prime mover 1 is reduced in response to a reduction in depression of the accelerator pedal 4 thereby reducing the drive force to propel the vehicle Ve. Given that the motor is adopted as the prime mover 1, a regenerative braking force derived from a regenerative torque of the motor is applied to the vehicle Ve when the accelerator pedal 4 is returned. By contrast, given that the engine is adopted as the prime mover 1, an engine braking force derived from a friction torque and a pumping loss is applied to the vehicle Ve when the accelerator pedal 4 is returned.

The brake device 6 is actuated to establish a brake force applied to the vehicle Ve by depressing the brake pedal 5. For example, a hydraulic disc brake and a drum brake may be adopted as the brake device 6. The brake device 6 may also be controlled by the ECU 8.

The detector 7 collects data about conditions of the vehicle Ve including conditions of the accelerator pedal 4 and the brake pedal 5. Specifically, the detector 7 comprises: an accelerator position sensor 7a that detects at least a position (or depression) of the accelerator pedal 4; a brake stroke sensor 7b that detects an operating amount (i.e., stroke or depression) of the brake pedal 5; a hydraulic sensor 7c that detects a hydraulic pressure applied to the brake device 6 or a pedal force applied to the brake pedal 5; a wheel speed sensor 7d that detects a speed of the vehicle ve; an acceleration sensor 7e that detects a longitudinal acceleration of the vehicle Ve; and a switch 7f that is manipulated by the driver to select a one-pedal mode. The detector 7 is electrically connected to the ECU 8 so that the data collected by those sensors are transmitted to the ECU 8 in the form of an electric signal.

The ECU 8 comprises a microcomputer as its main constituent. As described, the data collected by the detector 7 is sent to the ECU 8 to control the vehicle Ve, and the ECU 8 performs calculation using the incident data from the detector 7, and data and formulas stored in advance. Calculation results are transmitted from the ECU 8 in the form of command signal.

Specifically, the ECU 8 calculates a target drive torque to be generated by the prime mover 1 and a target acceleration (or deceleration) of the vehicle Ve based on the data transmitted from the accelerator position sensor 7a, and transmits the calculated target drive torque to the prime mover 1 in the form of command signal so as to control an output power of the prime mover 1. The ECU 8 also controls the drive force to propel the vehicle Ve or the drive force to decelerate the vehicle Ve in such a manner as to achieve the target acceleration or deceleration calculated based on a state of the accelerator pedal 4 or the brake pedal 5. Although only one ECU 8 is depicted in FIG. 1, a plurality of ECUs may be arranged in the vehicle Ve to control the specific devices individually.

The vehicle Ve may be propelled in the one-pedal mode in which not only the drive force but also the brake force are controlled in accordance with a position of the accelerator pedal 4. That is, in the one-pedal mode, acceleration of the vehicle Ve may be controlled by controlling drive force or regenerative force of the vehicle Ve by manipulating only the accelerator pedal 4. Optionally, in the one-pedal mode, the acceleration of the vehicle Ve may also be controlled by the brake pedal 5 as necessary. Whereas, in a normal mode, the drive force is changed in accordance with a position of the accelerator pedal 4, and the braking force is changed in accordance with a position of the brake pedal 5. Thus, an operating mode of the vehicle Ve may be selected from the one-pedal mode and the normal mode.

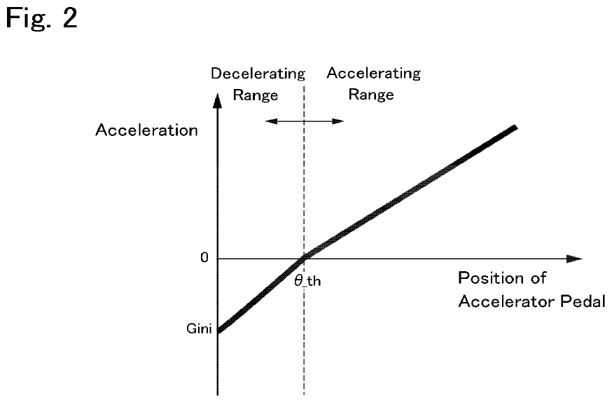

In the one-pedal mode, specifically, the drive force and the brake force are controlled in accordance with a position of the accelerator pedal 4 with reference to a map shown in FIG. 2. In FIG. 2, the horizontal axis represents a position of the accelerator pedal 4, and the vertical axis represents acceleration. As can be seen from FIG. 2, a range of position of the accelerator pedal 4 is divided into a decelerating range and an accelerating range across a reference position θth. Specifically, a range from an initial position of the accelerator pedal 4 (i.e., a depression is 0) to the reference position θth is the decelerating range, and a range from the reference position θth to a maximum position of the accelerator pedal 4 (i.e., a full throttle position) is the accelerating range. Given that the accelerator pedal 4 is positioned at the reference position θth, the prime mover 1 and the brake device 6 are controlled in such a manner as to reduce the drive force and the brake force to zero, respectively. Given that the accelerator pedal 4 is positioned within the accelerating range, the prime mover 1 increases the drive force to propel the vehicle Ve with an increase in depression of the accelerator pedal 4. By contrast, given that the accelerator pedal 4 is positioned within the decelerating range, the prime mover 1 and/or the brake device 6 increases the brake force to decelerate the vehicle Ve with a reduction in depression of the accelerator pedal 4.

Specifically, when the accelerator pedal 4 is fully depressed, the acceleration of the vehicle Ve is increased to a structural maximum acceleration possible to be established by the prime mover 1. However, if the deceleration is increased to a structural maximum deceleration when the accelerator pedal 4 is fully returned within a structural operation range of the accelerator pedal 4, the acceleration would be changed more than expected even if the driver changes a position of the accelerator pedal 4 only slightly. That is, it is difficult for the driver to adjust the acceleration finely in line with the driver's intension. According to the exemplary embodiment of the present disclosure, therefore, the deceleration of the of the vehicle Ve is increased only to a maximum deceleration required during normal running which is set based on statistic data, even when the accelerator pedal 4 is fully returned to the initial position. In other words, the maximum acceleration and the maximum deceleration are set in such a manner as to allow the driver to accelerate and decelerate the vehicle Ve by manipulating only the accelerator pedal 4, unless there is an emergency to stop the vehicle Ve.

Thus, in the one-pedal mode, the driver is allowed to accelerate and decelerate the vehicle Ve by manipulating only the accelerator pedal 4. However, when a deceleration greater than the maximum deceleration available in the one-pedal mode is required, the driver has to operate the brake pedal 5 even in the one-pedal mode. In addition, it would take some time to depress the brake pedal 5.

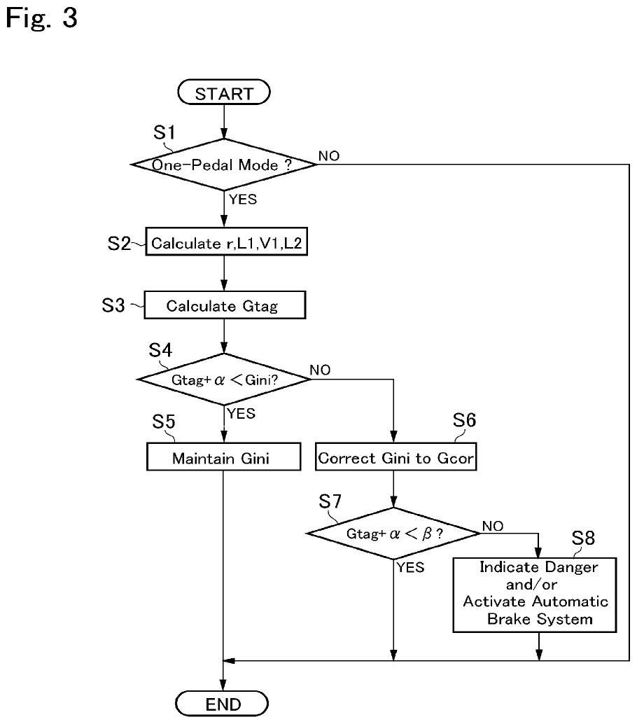

In order to avoid such disadvantages, the brake force control system according to the exemplary embodiment of the present disclosure is configured to detect a reason to decelerate the vehicle Ve during propulsion in the one-pedal mode, and to correct a magnitude of deceleration with respect to a position of the accelerator pedal 4 so as to achieve a required deceleration by manipulating only the accelerator pedal 4. For this purpose, the brake force control system executes a routine shown in FIG. 3.

At step S1, it is determined whether the vehicle Ve is propelled in the one-pedal mode. For example, such determination at step S1 may be made based on the signal transmitted from the switch 7f for selecting the one-pedal mode.

If the vehicle Ve is not propelled in the one-pedal mode so that the answer of step S1 is NO, it is not necessary to control the deceleration by the accelerator pedal 4 and hence the routine returns. By contrast, if the vehicle Ve is propelled in the one-pedal mode so that the answer of step S1 is YES, the brake force control system determines the possibility of execution of decelerating operation (i.e., an existence of a decelerating factor) based on information ahead of the vehicle Ve. If it is estimated that the vehicle will be decelerated, the brake force control system estimates a target deceleration expected by the driver during decelerating the vehicle Ve. For example, the decelerating factor includes a situation when travelling through a curve in a stable manner, a situation when decelerating the vehicle Ve to keep a distance from the vehicle ahead, and a situation when stopping the vehicle Ve at a traffic light or an intersection. Hereinafter, examples to decelerate the vehicle Ve to travel through a curve and to keep a distance from the vehicle ahead will be explained.

In order to estimate the target deceleration expected by the driver, at step S2, the brake force control system calculates: a radius r of a curve ahead of the vehicle Ve; a distance L1 to the curve ahead of the vehicle Ve; a speed V1 of the vehicle ahead of the vehicle Ve; and a distance L2 to the vehicle ahead of the vehicle Ve. For example, the radius r of a curve ahead of the vehicle Ve and the distance L1 to the curve ahead of the vehicle Ve may be calculated based on a map data of a navigation system, the distance L2 to the vehicle ahead of the vehicle Ve may be detected by a millimeter-wave radar, and the speed V1 of the vehicle ahead of the vehicle Ve may be calculated based on a time rate of change in the distance L2 and a speed V2 of the vehicle Ve. Optionally, in order to estimate the target deceleration, an inclination of a road to the curve ahead of the vehicle Ve, visibility of the curve ahead of the vehicle Ve, a friction coefficient of the road to the curve ahead of the vehicle Ve, a friction coefficient of the curve ahead of the vehicle Ve and so on may be obtained in addition to the above-mentioned parameters. Thus, at step S2, the parameters involved in controlling speed and deceleration of the vehicle Ve are calculated.

Then, at step S3, the target deceleration expected by the driver (as will be simply called the “target deceleration Gtag” hereinafter) is calculated based on the above-mentioned parameters. Here will be explained a procedure to calculate the target deceleration Gtag in the case that the vehicle Ve enters the curve ahead. In this case, if a lateral acceleration Glat when travelling through the is too large, understeer occurs and the vehicle Ve may not travel through the curve safely. The lateral acceleration Glat may be calculated based on a centrifugal force acting on the vehicle Ve travelling through the curve, and a relation among the lateral acceleration Glat, the vehicle speed V, and the radius r of the curve may be expressed as:

G=V²/r/9.8

That is, the target speed Vtag of the vehicle Ve is reduced with a reduction in the radius of the curve.

Accordingly, in order to calculate the target deceleration Gtag, a target speed Vtag of the vehicle Ve to travel through the curve is calculated based on the radius r of the curve calculated at step S2 and an acceptable lateral acceleration Glat.

Then, the target deceleration Gtag is calculated based on a current speed Vcur of the vehicle Ve, the target speed Vtag of the vehicle Ve, and a travel distance until the vehicle Ve is decelerated to the target speed Vtag (i.e., the distance L1 in this case), using the following formula:

Gtag=(Vtag−Vcur)/(L1/((Vtag+Vcur)/2) (2)

Accordingly, a location of the curve corresponds to a target site of the embodiment of the present disclosure.

In the case that the vehicle Ve follows the vehicle ahead, the target speed Vtag of the vehicle Ve may be set to a same speed as the speed V1 of the vehicle ahead of the vehicle Ve. In this case, the target speed Vtag of the vehicle Ve may be calculated using the following formula:

Gtag=(V2−V1)²/2/(L2−L3) (3)

where L3 is a target distance to the vehicle ahead which can be set depending on the target speed Vtag. Accordingly, a distance until the distance to the vehicle ahead is adjusted to the target distance L3 corresponds to a predetermined distance of the embodiment of the present disclosure.

If the target deceleration Gtag calculated at step S3 is greater than an initial maximum deceleration Gini established by returning the accelerator pedal 4 to the initial position (that is, when depression of the accelerator pedal 4 is zero), the driver has to depress the brake pedal 5 to achieve the target deceleration Gtag even in the one-pedal mode. Therefore, in order to achieve the target deceleration Gtag by operating only the accelerator pedal 4, the initial maximum deceleration Gini is corrected to be increased if the target deceleration Gtag calculated is greater than the initial maximum deceleration Gini. Accordingly, the initial maximum deceleration Gini corresponds to a reference deceleration of the embodiment of the present disclosure, and in the following description, the initial maximum deceleration Gini thus corrected will be referred to as the corrected initial maximum deceleration Gcor.

To this end, at step S4, it is determined whether the target deceleration Gtag is less than the initial maximum deceleration Gini. According to the exemplary embodiment of the present disclosure, a predetermined additional value α is added to the target deceleration Gtag to be compared to the initial maximum deceleration Gini at step S4. In a case of following the vehicle running through a curve ahead of the vehicle Ve, at step S3, not only a deceleration required to travel though the curve safely, but also a deceleration required to adjust the distance to the vehicle ahead to the target distance L3 are calculated as the target decelerations Gtag. That is, a plurality of the target decelerations Gtag are calculated at step S3 depending on number of the decelerating factors. In this case, the greatest target deceleration Gtag is compared to the initial maximum deceleration Gini at step S4.

If the target deceleration Gtag to which the predetermined additional value α is added is less than the initial maximum deceleration Gini so that the answer of step S4 is YES, the target deceleration Gtag expected by the driver can be achieved by the initial maximum deceleration Gini. In this case, therefore, the routine progresses to step S5 to maintain the initial maximum deceleration Gini. That is, the initial maximum deceleration Gini to be achieved by returning the accelerator pedal 4 will not be corrected. Thereafter, the routine returns.

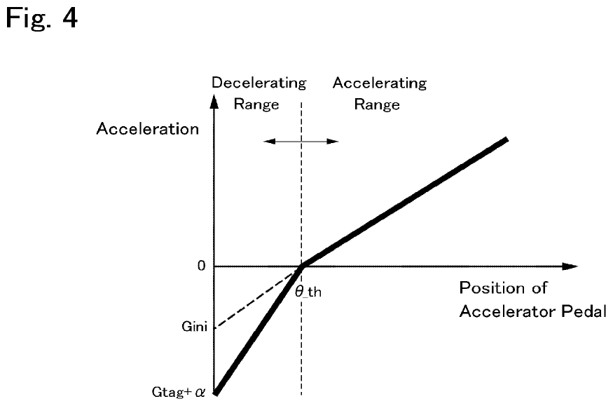

By contrast, if the target deceleration Gtag to which the predetermined additional value α is added is equal to or greater than the initial maximum deceleration Gini so that the answer of step S4 is NO, the routine progresses to step S6 to correct the initial maximum deceleration Gini to the corrected initial maximum deceleration Gcor, so as to generate the deceleration calculated by adding the predetermined additional value α to the target deceleration Gtag when the accelerator pedal 4 is returned to the initial position. Specifically, as indicated in FIG. 4, a change in the deceleration with respect to a position of the accelerator pedal 4 within the decelerating range is increased compared to that of the map shown in FIG. 2 indicated by the dashed line in FIG. 4.

Then, at step S7, it is determined whether the deceleration calculated by adding the predetermined additional value α to the target deceleration Gtag is less than an available value ß to adjust the deceleration. That is, at step S7, it is determined whether the vehicle Ve cannot travel through the curve in a stable manner or the distance from the vehicle ahead is reduced excessively, unless the vehicle Ve is decelerated by the maximum deceleration structurally possible to be generated. To this end, the available value ß is set to the maximum deceleration structurally possible to be generated to decelerate the vehicle Ve. Otherwise, the available value ß is set predetermined value smaller than the maximum deceleration structurally possible to be generated. Accordingly, the available value ß corresponds to a predetermined deceleration of the embodiment of the present disclosure.

If the deceleration calculated by adding the predetermined additional value α to the target deceleration Gtag is less than the available value ß so that the answer of step S7 is YES, it is not necessary to decelerate the vehicle Ve by the maximum deceleration structurally possible to be generated. In this case, therefore, the routine returns so that the deceleration is controlled by manipulating the accelerator pedal 4. By contrast, if the deceleration calculated by adding the predetermined additional value α to the target deceleration Gtag is greater than the available value ß so that the answer of step S7 is NO, it is necessary to generate the brake force urgently. In this case, therefore, the routine progresses to step S8 to indicate danger by e.g., a warning tone or to activate an automatic brake system thereby generating the brake force irrespective of position of the accelerator pedal, or to indicate danger by e.g., the warning tone and to activate the automatic brake system thereby generating the brake force irrespective of position of the accelerator pedal 4. Thereafter, the routine returns.

Thus, the target deceleration Gtag is calculated in accordance with the decelerating factor, and if the initial maximum deceleration Gini is equal to or less than the target deceleration Gtag, the map determining the deceleration is corrected in such a manner as to increase a change in the deceleration with respect to a position of the accelerator pedal 4. According to the exemplary embodiment of the present disclosure, therefore, the deceleration of the vehicle Ve may be controlled by manipulating only the accelerator pedal 4, without operating the brake pedal 5. In addition, since the driver is allowed to adjust the deceleration manually by manipulating the accelerator pedal 4, the deceleration of the vehicle Ve can be controlled in line with an intension of the driver. According to the exemplary embodiment of the present disclosure, therefore, uncomfortable feeling of the driver can be reduced.

Further, if the target deceleration Gtag is equal to or greater than the available value ß, the driver is urged to operate the brake pedal 5, or the automatic brake system is activated. According to the exemplary embodiment of the present disclosure, therefore, the vehicle Ve can be decelerated certainly to travel through a curve in a stable manner, and to keep an appropriate distance to the vehicle running ahead.

Although the above exemplary embodiments of the present disclosure have been described, it will be understood by those skilled in the art that the present disclosure should not be limited to the described exemplary embodiments, and various changes and modifications can be made within the scope of the present disclosure. For example, the reference position θth defining the decelerating range may be adjusted according to need. In addition, the deceleration to decelerate the vehicle Ve may also be calculated using a predetermined formula instead of using the map. Further, the change in deceleration with respect to a position of the accelerator pedal 4 may also be increased by multiplying the deceleration determined with reference to the map by a predetermined coefficient, instead of correcting the map.

What is claimed is:

1. A brake force control system for a vehicle, comprising:
a controller that controls a brake force based on a deceleration determined with respect to a position of an accelerator pedal within a predetermined range,
wherein the controller is configured to
calculate a target deceleration to travel through a target site existing a predetermined distance ahead of the vehicle at a target speed, in accordance with a decelerating factor determined based on information ahead of the vehicle, and
correct a reference deceleration generated by returning the accelerator pedal to an initial position, if the reference deceleration is equal to or less than the target deceleration.

2. The brake force control system for the vehicle as claimed in claim 1, wherein the corrected reference deceleration is set to the target deceleration.

3. The brake force control system for the vehicle as claimed in claim 1, wherein the controller is further configured to
calculate a plurality of the target decelerations depending on number of the decelerating factors, and
compare the greatest target deceleration to the reference deceleration to correct the reference deceleration.

4. The brake force control system for the vehicle as claimed in claim 1, wherein the controller is further configured to
indicate danger or to activate an automatic brake system thereby generating the brake force irrespective of the position of the accelerator pedal, or
indicate danger and to activate the automatic brake system thereby generating the brake force irrespective of the position of the accelerator pedal, if the target deceleration is equal to or greater than the predetermined deceleration.

5. The brake force control system for the vehicle as claimed in claim 1, wherein the target deceleration is calculated based on a current speed of the vehicle, the target speed, and the predetermined distance to the target site.

6. The brake force control system for the vehicle as claimed in claim 1,
wherein the decelerating factor includes a situation when travelling through a curve in a stable manner, and
the controller is further configured to reduce the target speed with a reduction in a radius of the curve.

7. The brake force control system for the vehicle as claimed in claim 1,
wherein the decelerating factor includes a situation when decelerating the vehicle to keep a distance from a vehicle running ahead, and
the target speed is calculated taking account of a speed of the vehicle running ahead.

8. The brake force control system for the vehicle as claimed in claim 1,
wherein the controller comprises a map increasing the deceleration with a reduction in depression of the accelerator pedal toward the initial position within the predetermined range, and
the controller is further configured to correct the map in such a manner as to increase a change in the deceleration with respect to the position of the accelerator pedal if the reference deceleration is equal to or less than the target deceleration.
